(19) United States
(12) Patent Application Publication
(10) Pub. No.: US 2026/0166909 A1
(43) Pub. Date: Jun. 18, 2026

(54) ANTI-COUNTERFEITING ELEMENT AND ANTI-COUNTERFEITING PRODUCT

(71) Applicants: ZHONGCHAO SPECIAL SECURITY TECHNOLOGY CO., LTD, Beijing (CN); CHINA BANKNOTE PRINTING AND MINTING CORP., Beijing (CN)

(72) Inventors: Chunhua Hu, Beijing (CN); Dong Yang, Beijing (CN); Yuanqi Wu, Beijing (CN); Dong Ye, Beijing (CN)

(21) Appl. No.: 18/710,445

(22) PCT Filed: Aug. 4, 2022
(86) PCT No.: PCT/CN2022/110340

§ 371 Date: May 15, 2024

(30) Foreign Application Priority Data
Nov. 15, 2021 (CN) 202111350993.1

(51) Int. Cl. B42D 25/373; B42D 25/29; B42D 25/324; B42D 25/328; B42D 25/351; B42D 25/378

(52) U.S. Cl. CPC B42D 25/373; B42D 25/29; B42D 25/324; B42D 25/328; B42D 25/351; B42D 25/378

(57) ABSTRACT

Disclosed are an anti-counterfeiting element and an anti-counterfeiting product. The anti-counterfeiting element comprises: a substrate (1), the substrate comprising a first surface and a second surface opposite to each other; a microlens array layer (2), the microlens array layer being located on the first surface of the substrate; a micrographic array layer (3), the micrographic array layer being located on the second surface of the substrate, a side surface of the micrographic array layer far away from the substrate comprising at least micrographic areas and micrographic background areas, there being multiple micrographic areas and multiple micrographic background areas, and the areas being alternately arranged; a second color layer (6), the second color layer being located on the side surface of the micrographic array layer far away from the substrate; and first color layers (4), the first color layers being located between the micrographic array layer and the second color layer, there being multiple first color layers, and the multiple first color layers being in one-to-one correspondence with the multiple micrographic areas, wherein one of the first color layer and the second color layer is a metal plating layer and the other is an interference light variable layer. The problem of poor anti-counterfeiting performance of anti-counterfeiting elements in the prior art is solved.

### CROSS-REFERENCE TO RELATED APPLICATION

This application claims priority to Chinese Patent Application No. 202111350993.1, entitled “ANTI-COUNTERFEITING ELEMENT AND ANTI-COUNTERFEITING PRODUCT” filed on the State Intellectual Property Office of P. R. China on Nov. 15, 2021, which is incorporated by reference in its entirety.

### TECHNICAL FIELD

The disclosure relates to the field of the anti-counterfeiting technology, and more specifically, to an anti-counterfeiting element and an anti-counterfeiting product.

### BACKGROUND

In order to prevent the production or forgery of various high safety or high added value printed products such as banknotes, certificates and product packages by means of scanning, copying and the like, optical anti-counterfeiting elements such as safety lines, stickers or labels are widely used therein. There are various anti-counterfeiting technologies used in optical anti-counterfeiting elements, wherein the holographic anti-counterfeiting technology is the most common anti-counterfeiting technology at present, such as the window opening safety line of the China's fifth set of RMB (version 2005), except for the 1 yuan voucher, as well as important documents such as China's ID card, driver's license, passport, etc.

With the development of the technology, the interference light variable technology has received increasing attention due to its specific optical color change effects under different observation perspectives. The interference light variable technology generally uses a method of vapor deposition to form a multi-layer interference plating. A classical multi-layer interference plating generally comprises a reflecting layer, a dielectric layer and an absorption layer. The reflecting layer is generally prepared from high-brightness metal materials, the dielectric layer is generally prepared from transparent inorganic or organic materials, and the absorption layer, also known as a semi-transparent layer, is generally prepared from thinner metal materials with good absorptivity. The safety line of 100 yuan in the fifth set of RMB (version 2015) uses the multi-layer interference light variable technology, and is magenta during front observation and green during oblique observation. In addition, in recent years, the optically variable ink (OVI) based on the principle of the interference light variable technology has also received attention from banknotes and other high-end commercial anti-counterfeiting industries due to easy integration with the traditional printing industry. For example, front face denomination numbers of 100 yuan in the fifth set of RMB (version 2015), 50 yuan, 20 yuan and 10 yuan in the version 2019, and 5 yuan in the version 2020 all use the OVI.

On the other hand, with the use of Motion safety lines in the new version of US dollar banknotes, the anti-counterfeiting industry has shown strong interest in this new type of microlens array technology, and it is an anti-counterfeiting technology with dynamic features or depth of field effects generated based on the Moire amplification effect of a microlens array on a micrographic array, that is, the microlens array can perform sampling and synthesis on the micrographic array to form an image. The image presents a violent motion effect with changes in observation angle. This technology requires the micrographic array and the background thereof to have a sufficient color or brightness contrast. The patent document CN200680062431.9 discloses a method for producing micrographics in an ink scraping manner, that is, first, a fluctuant structure layer with an icon concave structure is formed and then is integrally coated with a certain thickness of radiation curing ink, then, an ink scraper is used for scraping off the ink outside the concave structure, and finally, the radiation curing ink in the concave structure is subjected to radiation curing by a certain dose of radiation sources. Micrographic lines obtained by this method can only be very thin, for example, it is difficult to achieve lines with a width greater than 5 μm. The design for products is rigorous, as some product designs require relatively thick or even macroscopic lines. In addition, the graphic color obtained by this method is the color of the ink itself, so the appearance is relatively simple.

The single holographic technology, interference light variable technology and even microlens array technology are increasingly applied in ordinary market products, such as decorative products. Therefore, it is highly necessary to improve the comprehensive anti-counterfeiting ability of these technologies.

That is to say, anti-counterfeiting elements in the prior art have the problem of poor anti-counterfeiting performance.

### SUMMARY

Some embodiments of the disclosure are to provide an anti-counterfeiting element and an anti-counterfeiting product to solve the problem of poor anti-counterfeiting performance of anti-counterfeiting elements in the prior art.

In order to achieve the above purpose, according to one aspect of the disclosure, an anti-Attorney counterfeiting element is provided. The anti-counterfeiting element comprises: a substrate, the substrate comprising a first surface and a second surface opposite to each other; a microlens array layer, the microlens array layer being located on the first surface of the substrate; a micrographic array layer, the micrographic array layer being located on the second surface of the substrate, a side surface of the micrographic array layer far away from the substrate comprising at least micrographic areas and micrographic background areas, there being multiple micrographic areas and multiple micrographic background areas, and the areas being alternately arranged; a second color layer, the second color layer being located on the side surface of the micrographic array layer far away from the substrate; and first color layers, the first color layers being located between the micrographic array layer and the second color layer, there being multiple first color layers, and the multiple first color layers being in one-to-one correspondence with the multiple micrographic areas, wherein one of the first color layer and the second color layer is a metal plating layer and the other is an interference light variable layer.

In an embodiment mode, the depth-to-width ratio of each micrographic area of the multiple micrographic areas on the micrographic array layer is less than the depth-to-width ratio of each micrographic background area of the multiple micrographic background areas on the micrographic array layer; and/or the specific volume of each micrographic area of the multiple micrographic areas on the micrographic array layer is less than the specific volume of each micrographic background area of the multiple micrographic background areas on the micrographic array layer.

In an embodiment mode, the depth-to-width ratio of each micrographic area of the multiple micrographic areas on the micrographic array layer is less than 0.3; and/or the depth-to-width ratio of each micrographic background area of the multiple micrographic background areas on the micrographic array layer is greater than 0.3.

In an embodiment mode, the specific volume of each micrographic area of the multiple micrographic areas on the micrographic array layer is greater than or equal to 0μm³ /μm² and less than 0.5μm³ /μm²; and/or the specific volume of each micrographic background area of the multiple micrographic background areas on the micrographic array layer is greater than 0.4μm³ /μm² and less than 2 μm³/μm².

In an embodiment mode, the micrographic area comprises multiple lines, the width of a part of the multiple lines is less than 5 μm, and the width of the other part of the lines is greater than 5 μm; and/or the micrographic background area comprises multiple lines, the width of a part of the multiple lines is less than 5 μm, and the width of the other part of the lines is greater than 5 μm.

In an embodiment mode, the metal plating layer comprises one of aluminum, silver, copper, tin, chromium, nickel and titanium.

In an embodiment mode, the interference light variable layer comprises an absorption layer, a dielectric layer and a reflecting layer which are stacked in sequence, and the absorption layer is arranged closer to the micrographic array layer compared to the reflecting layer; the absorption layer comprises one of aluminum, nickel, chromium, silver, copper, tin and titanium; and/or the dielectric layer comprises one of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ and ZnO; and/or the reflecting layer comprises one of aluminum, silver, copper, tin, chromium, nickel and titanium.

In an embodiment mode, the interference light variable layer is composed of optically variable ink (OVI).

In an embodiment mode, the anti-counterfeiting element further comprises a microstructure alleviation layer, and the microstructure alleviation layer is located between the first color layer and the second color layer.

In an embodiment mode, a side surface of the microstructure alleviation layer facing the second color layer is a plane.

According to another aspect of the disclosure, an anti-counterfeiting product is provided, comprising the above anti-counterfeiting element.

In an embodiment mode, the anti-counterfeiting product comprises one of a label, a hot stamping wide strip, a sticker and a safety line.

Applying the technical solution of the disclosure, an anti-counterfeiting element comprises a substrate, a microlens array layer, a micrographic array layer, a second color layer and first color layers, wherein the substrate comprises a first surface and a second surface opposite to each other; the microlens array layer is located on the first surface of the substrate; the micrographic array layer is located on the second surface of the substrate, a side surface of the micrographic array layer far away from the substrate comprises at least micrographic areas and micrographic background areas, there are multiple micrographic areas and multiple micrographic background areas, and the areas are alternately arranged; the second color layer is located on the side surface of the micrographic array layer far away from the substrate; and the first color layers are located between the micrographic array layer and the second color layer, there are multiple first color layers, and the multiple first color layers are in one-to-one correspondence with the multiple micrographic areas, wherein one of the first color layer and the second color layer is a metal plating layer and the other is an interference light variable layer.

By arranging the microlens array layer and the micrographic array layer, the microlens array layer performs sampling and synthesis on the micrographic array layer to form an enlarged image. Because the micrographic area of the micrographic array layer is corresponding to the first color layer and the micrographic background area is corresponding to the second color layer, after the Moire amplification of the microlens array layer, as the observation angle changes, in addition to a dynamic effect formed by the Moire amplification effect, the micrographic area also presents specific optical effects, such as a holographic effect and a relief effect, and the micrographic area and the micrographic background area have different color effects. When the first color layer is a metal plating layer and the second color layer is an interference light variable layer, after imaging, the micrographic area has display features of the metal plating layer, and the micrographic background area has the feature of changing colors according to different observation angles, thus further enhancing the anti-counterfeiting ability of the anti-counterfeiting element, and ensuring the use reliability of the anti-counterfeiting element.

### BRIEF DESCRIPTION OF THE DRAWINGS

The accompanying drawings of the specification that constitute a part of the disclosure are used for providing a further understanding of the disclosure. The exemplary embodiments of the disclosure and the descriptions thereof are used for explaining the disclosure, and do not constitute an improper limitation on the disclosure. In the accompanying drawings:

FIG. 1 shows a schematic structural diagram of an anti-counterfeiting element in an embodiment of the disclosure;

FIG. 2 shows a schematic structural diagram of an anti-counterfeiting element in another embodiment of the disclosure; and

FIG. 3 shows a schematic structural diagram of an anti-counterfeiting element in still another embodiment of the disclosure.

The above accompanying drawings have the following reference numerals:
1. substrate; 2. microlens array layer; 3. micrographic array layer; A. micrographic area; B. micrographic background area; 4. first color layer; 5. microstructure alleviation layer; 6. second color layer; 61. absorption layer; 62. dielectric layer; 63. reflecting layer; 7. hot melt adhesive layer.

### DETAILED DESCRIPTION OF THE EMBODIMENTS

It should be noted that in the case of no conflict, the embodiments in the disclosure and the features in the embodiments may be combined with each other. The disclosure will be described in detail below with reference to the accompanying drawings in conjunction with the embodiments.

It should be noted that unless otherwise specified, all technical and scientific terms used in the disclosure have the same meanings as commonly understood by those skilled in the art of the disclosure.

In the disclosure, unless otherwise specified, the used directional words such as “upper, lower, top and bottom” are usually related to the directions shown in the accompanying drawings, or related to the upright, vertical or gravity directions of components. Similarly, for the convenience of understanding and description, “inside and outside” refer to the inside and outside relative to the contour of each component, but the above directional words are not intended to limit the disclosure.

In order to solve the problem of poor anti-counterfeiting performance of anti-counterfeiting elements in the prior art, the disclosure provides an anti-counterfeiting element and an anti-counterfeiting product.

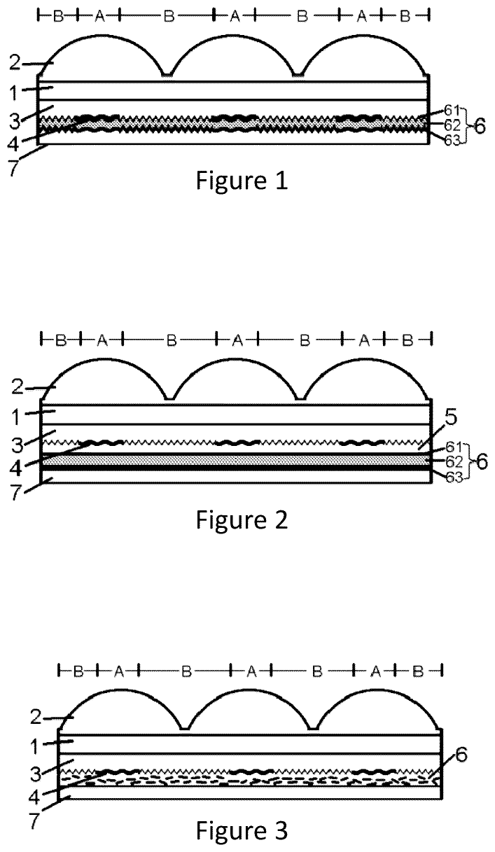

As shown in FIG. 1 to FIG. 3, an anti-counterfeiting element comprises a substrate 1, a microlens array layer 2, a micrographic array layer 3, a second color layer 6 and first color layers 4, wherein the substrate 1 comprises a first surface and a second surface opposite to each other; the microlens array layer 2 is located on the first surface of the substrate 1; the micrographic array layer 3 is located on the second surface of the substrate 1, a side surface of the micrographic array layer 3 far away from the substrate 1 comprises at least micrographic areas A and micrographic background areas B, there are multiple micrographic areas A and multiple micrographic background areas B, and the areas are alternately arranged; the second color layer 6 is located on the side surface of the micrographic array layer 3 far away from the substrate 1; and the first color layers 4 are located between the micrographic array layer 3 and the second color layer 6, there are multiple first color layers 4, and the multiple first color layers 4 are in one-to-one correspondence with the multiple micrographic areas A, wherein one of the first color layer 4 and the second color layer 6 is a metal plating layer and the other is an interference light variable layer.

By arranging the microlens array layer 2 and the micrographic array layer 3, the microlens array layer 2 performs sampling and synthesis on the micrographic array layer 3 to form an enlarged image. Because the micrographic area A of the micrographic array layer 3 is corresponding to the first color layer 4 and the micrographic background area B is corresponding to the second color layer 6, after the Moire amplification of the microlens array layer 2, as the observation angle changes, in addition to a dynamic effect formed by the Moire amplification effect, the micrographic area A also presents specific optical effects, such as a holographic effect and a relief effect, and the micrographic area A and the micrographic background area B have different color effects. When the first color layer 4 is a metal plating layer and the second color layer 6 is an interference light variable layer, after imaging, the micrographic area A has display features of the metal plating layer, and the micrographic background area B has the feature of changing colors according to different observation angles, thus further enhancing the anti-counterfeiting ability of the anti-counterfeiting element, and ensuring the use reliability of the anti-counterfeiting element.

The disclosure relates to an anti-counterfeiting element suitable for various high safety or high added value products such as banknotes, certificates and product packages, and relates to a product with the anti-counterfeiting element.

It should be noted that the micrographic area A and the micrographic background area B are artificially divided for the sake of brevity of description, but are not absolute. For example, for an Arabic numeral, it can be considered that the numeral is the micrographic area A and the other areas are the micrographic background areas B, or it can also be considered that the numeral is the micrographic background area B and the other areas are the micrographic areas A.

It should be noted that in the disclosure, the first color layer 4 is a metal plating layer, and the second color layer 6 is an interference light variable layer. Certainly, the selection may also be made according to actual situations.

Observing from the side of the substrate 1 with the microlens array layer 2, the microlens array layer 2 of the anti-counterfeiting element can perform sampling and synthesis on the micrographic array layer 3 to form an enlarged image; and after imaging, the micrographic area A has the features combining the self-features and the features of the first color layer 4, and the micrographic background area B has the features of the second color layer 6. Although both the micrographic area A and the micrographic background area B are integrally provided with the second color layer 6, namely the interference light variable layer, because the metal plating layer is sandwiched between the micrographic array layer 3 and the interference light variable layer, observing from one side of the microlens array layer 2, the interference light variable layer corresponding to the micrographic area A is invisible.

Preferably, the microlens array layer 2 is a columnar microlens array. If the observation angle obliquely changes perpendicular to the stretching direction of the columnar microlens, it can be seen that the micrographic area A has obvious dynamic features formed by the Moire principle, such as motion, scaling and distortion, and color change features are not obvious. If the observation angle changes along the stretching direction of the columnar microlens, it can be seen that the micrographic background area B has obvious color change features, and the micrographic area A does not have obvious dynamic features formed by the Moire principle. This visual effect effectively increases the recognizability of the anti-counterfeiting element.

To facilitate the disclosure on a protected product, the anti-counterfeiting element should not be too thick. In this way, the focal length of the microlens array layer 2 is generally required to be between 10 μm and 100 μm. Correspondingly, the periods of the microlens array layer 2 and the micrographic array layer 3 are both between 10 μm and 100 μm. By using the anti-counterfeiting element of the disclosure, the sizes of lines of the micrographic area A and the micrographic background area B are not limited. The lines may contain ultra-fine lines such as lines with a width less than 8 μm, or relatively macroscopic lines such as lines with a width greater than 20 μm, or ultra-fine lines and macroscopic lines at the same time.

Specifically, the micrographic area A comprises multiple lines, the width of a part of the multiple lines is less than 5 μm, and the width of the other part of the lines is greater than 5 μm; and the micrographic background area B comprises multiple lines, the width of a part of the multiple lines is less than 5 μm, and the width of the other part of the lines is greater than 5 μm. The sizes of the lines may be set according to actual situations.

In order to achieve high-fineness production of lines of the micrographic area A and the micrographic background area B, that is, to achieve precise removal of the metal plating layer of the micrographic background area B, it is necessary to use a unique non-traditional metal layer hollowing technology, commonly known as a precise hollowing technology. The fineness of lines achieved by a traditional printing hollowing technology is generally greater than 100 μm, which is difficult to meet the integration with a microlens array technology. Patent documents CN200680006666.1 and CN201510954137.5 disclose methods for achieving a precise hollowing technology based on different technical principles. The former utilizes the difference in depth-to-width ratio of the microstructure to achieve precise hollowing, and the latter utilizes the difference in specific volume of the microstructure to achieve precise hollowing. The depth-to-width ratio of the microstructure mentioned here refers to a ratio of the depth of the microstructure to the width along a periodic direction. The specific volume of the microstructure refers to a ratio of the volume of liquid that just completely covers the surface of the microstructure when the microstructure layer is placed in a horizontal state to the projected area of the microstructure on a horizontal plane. According to this definition, the depth-to-width ratio is a dimensionless physical quantity, and the dimension of the specific volume is μm³/μm². According to this definition, a flat structure is considered that the depth-to-width ratio is 0, and the specific volume is 0. The depth-to-width ratio and the specific volume are two physical quantities that are not directly related in quantity. For example, a structure C is a one-dimensional serrated grating with a depth of 1 μm and a period of 1 μm, thus the depth-to-width ratio is 1, and the specific volume is 0.5 μm³/μm²; and a structure D is a one-dimensional serrated grating with a depth of 2 μm and a period of 4 μm, thus the depth-to-width ratio is 0.5, and the specific volume is 1μm³ /μm². If the depth-to-width ratio of the microstructure of the micrographic area A is less than the depth-to-width ratio of the microstructure of the micrographic background area B, the precise removal of the metal plating layer of the micrographic background area B can be implemented according to the method disclosed in the patent CN200680006666.1. If the specific volume of the microstructure of the micrographic area A is less than the specific volume of the microstructure of the micrographic background area B, the precise removal of the metal plating layer of the micrographic background area B can be implemented according to the method disclosed in the patent CN201510954137.5. If the depth-to-width ratio of the microstructure of the micrographic area A is less than the depth-to-width ratio of the microstructure of the micrographic background area B and the specific volume of the microstructure of the micrographic area A is less than the specific volume of the microstructure of the micrographic background area B, the precise removal of the metal plating layer of the micrographic background area B can be implemented according to the method disclosed in the patent CN200680006666.1 or the method disclosed in the patent CN201510954137.5.

Specifically, the depth-to-width ratio of each micrographic area of the multiple micrographic areas A on the micrographic array layer 3 is less than the depth-to-width ratio of each micrographic background area of the multiple micrographic background areas B on the micrographic array layer 3; and the specific volume of each micrographic area of the multiple micrographic areas A on the micrographic array layer 3 is less than the specific volume of each micrographic background area of the multiple micrographic background areas B on the micrographic array layer 3. The depth-to-width ratio of each micrographic area of the multiple micrographic areas A on the micrographic array layer 3 can be understood as the depth-to-width ratio of the microstructure of the micrographic area A mentioned above, the depth-to-width ratio of each micrographic background area of the multiple micrographic background areas B on the micrographic array layer 3 can be understood as the depth-to-width ratio of the microstructure of the micrographic background area B mentioned above, the specific volume of each micrographic area of the multiple micrographic areas A on the micrographic array layer 3 can be understood as the specific volume of the microstructure of the micrographic area A mentioned above, and the specific volume of each micrographic background area of the multiple micrographic background areas B on the micrographic array layer 3 can be understood as the specific volume of the microstructure of the micrographic background area B mentioned above.

Specifically, the micrographic area A of the disclosure requires a high-brightness metal plating layer, so the depth-to-width ratio of each micrographic area of the multiple micrographic areas A is smaller to ensure the reflectivity of the metal plating layer. The depth-to-width ratio of each micrographic area of the multiple micrographic areas A on the micrographic array layer 3 is less than 0.3; and the depth-to-width ratio of each micrographic background area of the multiple micrographic background areas B on the micrographic array layer 3 is greater than 0.3. Preferably, the microstructure of the micrographic area A is a grating structure with a depth less than 200 nm and a width greater than 800 nm. The microstructure of the micrographic area A can provide special optical effects for the metal plating layer, such as a holographic effect and a relief effect, and parameters are set according to specific product requirements. The specific volume of each micrographic area of the multiple micrographic areas A on the micrographic array layer 3 is greater than or equal to 0 μm³/μm² and less than 0.5μm³ /μm²; and the specific volume of each micrographic background area of the multiple micrographic background areas B on the micrographic array layer 3 is greater than 0.4μm³ /μm² and less than 2 μm³/μm².

Specifically, the metal plating layer comprises one of aluminum, silver, copper, tin, chromium, nickel and titanium. Certainly, the metal plating layer may also be composed of alloys of aluminum, silver, copper, tin, chromium, nickel and titanium. Due to the high brightness and low cost of aluminum, the preferred material for the metal plating layer is aluminum.

Specifically, the interference light variable layer has determined and obviously different color features respectively during front observation and oblique observation, and thus has a very high anti-counterfeiting effect. The interference light variable layer comprises an absorption layer 61, a dielectric layer 62 and a reflecting layer 63 which are stacked in sequence. The absorption layer 61 is arranged closer to the micrographic array layer 3 compared to the reflecting layer 63. The absorption layer 61 comprises one of aluminum, nickel, chromium, silver, copper, tin and titanium, or is composed of the alloys thereof. The dielectric layer 62 comprises one of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ and ZnO. The reflecting layer 63 comprises one of aluminum, silver, copper, tin, chromium, nickel and titanium, or is composed of the alloys thereof.

If the arrangement of the microstructure of the micrographic background area B can form specific optical effects, such as a dynamic effect and a scaling effect, the micrographic background area B after Moire amplification has optical effects combining specific optical effects and interference light variable effects.

In another embodiment as shown in FIG. 2, the anti-counterfeiting element further comprises a microstructure alleviation layer 5, and the microstructure alleviation layer 5 is located between the first color layer 4 and the second color layer 6. Due to the need for hollowing, the depth of the microstructure of the micrographic background area B is usually large, and the brightness of the interference light variable layer formed directly may be poor. Preferably, first, a microstructure alleviation layer 5 with a certain thickness is coated, and then, an interference light variable layer is formed. After the microstructure alleviation layer 5 is coated, the microstructure of the micrographic background area B appropriately shallows, the color of the interference light variable layer is brighter, and the specific optical effects presented by the microstructure are not affected. A thicker microstructure alleviation layer 5 may also be coated, and the microstructure is flattened into a flat structure. In this way, although the micrographic background area B no longer presents specific optical effects, the interference efficiency and color saturation of the interference light variable layer on the flat structure are the highest. A side surface of the microstructure alleviation layer 5 facing the second color layer 6 is a plane.

In still another embodiment as shown in FIG. 3, the interference light variable layer is composed of optically variable ink (OVI). The pigment of the OVI is a pulverized interference light variable plating sheet. Generally, the pigment sheet of the OVI is larger and can completely cover the microstructure of the micrographic background area B, so the specific optical effects of the microstructure cannot be presented. After ink film forming and drying, pigment sheets are basically arranged along the plane of the interference light variable layer to form color change effects similar to those of the interference light variable layer.

As shown in FIG. 1 to FIG. 3, in order to achieve functions such as bonding between the anti-counterfeiting element and a protected product, the anti-counterfeiting element further comprises a hot melt adhesive layer 7, and the hot melt adhesive layer 7 is connected to a side surface of the second color layer 6 far away from the substrate 1. Certainly, the hot melt adhesive layer 7 may also be a coating with other functions.

The disclosure further provides an anti-counterfeiting product, comprising the above anti-counterfeiting element. Specifically, the anti-counterfeiting product comprises one of a label, a hot stamping wide strip, a sticker and a safety line.

FIG. 1 to FIG. 3 respectively show three embodiments of an anti-counterfeiting element of the disclosure.

FIG. 1 is a cross-sectional diagram of an exemplary anti-counterfeiting element according to an embodiment of the disclosure. A substrate 1 is composed of a biaxially oriented polypropylene (BOPP) film with a thickness of 70 μm. A microlens array layer 2 formed by multiple columnar microlenses is formed on a first surface of the substrate 1, the microlens array layer 2 is formed by curing UV resin through UV light irradiation, the period of the microlens array layer 2 is 50 μm, and the height is 10 μm. A micrographic array layer 3 is formed on a second surface of the substrate 1, the micrographic array layer 3 is formed by curing UV resin through UV light irradiation, the period is 50.2 μm, and the thickness is 5 μm. A side surface of the micrographic array layer 3 far away from the substrate 1 is divided into micrographic areas A and micrographic background areas B according to different specific volumes of microstructures on the surface, wherein the depth of the microstructure of the micrographic area A is 0.1-0.2 μm, the period is 0.8-10 μm, and a Fresnel grating structure with a three-dimensional relief effect can be formed; and the depth of the microstructure of the micrographic background area B is 1 μm, the period is 4 μm, and the micrographic background areas B can be arranged transversely to form a microreflector grating structure with scroll bar features. The micrographic area A of the micrographic array layer 3 is provided with a first color layer 4, namely a metal plating layer, the metal plating layer is an aluminum layer, the thickness of the aluminum layer is 30 nm, and the micrographic background area B is not provided with a metal plating layer. The micrographic area A and the micrographic background area B are integrally provided with a second color layer 6, namely an interference light variable layer. The aluminum layer is sandwiched between the micrographic array layer 3 and the interference light variable layer. The interference light variable layer is composed of an absorption layer 61, a dielectric layer 62 and a reflecting layer 63, wherein materials are respectively Ni, SiO₂ and Al, and thicknesses are respectively 5 nm, 380 nm and 50 nm. The anti-counterfeiting element further comprises a hot melt adhesive layer 7 for bonding a protected product.

Observing from one side of the microlens array layer 2, if the observation angle obliquely changes along the stretching direction of the columnar microlens, it can be seen that the micrographic background area B is golden during front observation and green during oblique observation, and also has scroll bar features; and if the observation angle obliquely changes perpendicular to the stretching direction of the columnar microlens, it can be seen that three-dimensional relief graphics have obvious dynamic features formed by the Moire principle (such as motion, scaling and distortion).

FIG. 2 is a cross-sectional diagram of another exemplary anti-counterfeiting element according to an embodiment of the disclosure. The substrate 1 is composed of a polyethylene terephthalate (PET) film with a thickness of 15 μm. A microlens array layer 2 formed by multiple columnar microlenses is formed on a first surface of the substrate 1, the microlens array layer 2 is formed by curing UV resin through UV light irradiation, the period of the microlens array layer 2 is 25 μm, and the height is 5 μm. A micrographic array layer 3 is formed on a second surface of the substrate 1, the micrographic array layer 3 is formed by curing UV resin through UV light irradiation, the period is 25.1 μm, and the thickness is 5 μm. A side surface of the micrographic array layer 3 far away from the substrate 1 is divided into micrographic areas A and micrographic background areas B according to different depth-to-width ratios of microstructures on the surface, wherein the depth of the microstructure of the micrographic area A is 0.1-0.15 μm, the period is 0.8-1.2 μm, and a cosine grating is formed on a cross section; and the depth of the microstructure of the micrographic background area B is 0.3 μm, the period is 1 μm, and a cosine grating is formed on a cross section. The micrographic area A of the micrographic array layer 3 is provided with a first color layer 4, namely a metal plating layer, the metal plating layer is an aluminum layer, the thickness of the aluminum layer is 30 nm, and the micrographic background area B is not provided with an aluminum layer. The micrographic area A and the micrographic background area B are integrally provided with a microstructure alleviation layer 5 with a thickness of 4 μm. The aluminum layer is sandwiched between the micrographic array layer 3 and the interference light variable layer. Because the refractive index of the material of the micrographic array layer 3 is basically the same as the refractive index of the material of the microstructure alleviation layer 5, an interface of the micrographic background area B at the micrographic array layer 3 is basically invisible. A flat structure is formed on the side of the microstructure alleviation layer 5 far away from the substrate 1. The microstructure alleviation layer 5 is integrally provided with an interference light variable layer. The interference light variable layer is composed of an absorption layer 61, a dielectric layer 62 and a reflecting layer 63, materials are respectively Ni, SiO₂ and Al, and thicknesses are respectively 5 nm, 380 nm and 50 nm. The absorption layer 61 is connected to the microstructure alleviation layer 5. The anti-counterfeiting element further comprises a hot melt adhesive layer 7 for bonding a protected product. Observing from one side of the microlens array layer 2, if the observation angle obliquely changes along the stretching direction of the columnar microlens, it can be seen that the micrographic background area B is high-saturation golden during front observation and high-saturation green during oblique observation; and if the observation angle obliquely changes perpendicular to the stretching direction of the columnar microlens, it can be seen that the micrographic area A with rainbow holographic features has obvious dynamic features formed by the Moire principle (such as motion, scaling and distortion).

FIG. 3 is a cross-sectional diagram of still another exemplary anti-counterfeiting element according to an embodiment of the disclosure. The substrate 1 is composed of a polyethylene terephthalate (PET) film with a thickness of 15 μm. A microlens array layer 2 formed by multiple columnar microlenses is formed on a first surface of the substrate 1, the microlens array layer 2 is formed by curing UV resin through UV light irradiation, the period of the microlens array layer 2 is 25 μm, and the height is 5 μm. A micrographic array layer 3 is formed on a second surface of the substrate 1, the micrographic array layer 3 is formed by curing UV resin through UV light irradiation, the period is 25.1 μm, and the thickness is 5 μm. A side surface of the micrographic array layer 3 far away from the substrate 1 is divided into micrographic areas A and micrographic background areas B according to different depth-to-width ratios of microstructures on the surface, wherein the depth of the microstructure of the micrographic area A is 0.1 μm- 0.15 μm, the period is 0.8-1.2 μm, and a cosine grating is formed on a cross section; and the depth of the microstructure of the micrographic background area B is 0.3 μm, the period is 1 μm, and a cosine grating is formed on a cross section. The micrographic area A of the micrographic array layer 3 is provided with a first color layer 4, namely a metal plating layer, the metal plating layer is an aluminum layer, the thickness of the aluminum layer is 30 nm, and the micrographic background area B is not provided with an aluminum layer. The micrographic area A and the micrographic background area B are integrally provided with a second color layer 6. In this embodiment, the second color layer 6 is an interference light variable layer, and the interference light variable layer is composed of optically variable ink (OVI). The aluminum layer is sandwiched between the micrographic array layer 3 and the interference light variable layer. Because the refractive index of the material of the micrographic array layer 3 is basically the same as the refractive index of the binding material in the OVI, an interface of the micrographic background area B at the micrographic array layer 3 is basically invisible. The pigment of the OVI is a pulverized interference light variable plating sheet, such as Ni, SiO₂, Al, SiO₂ and Ni, thicknesses are respectively 5 nm, 380 nm, 50 nm, 380 nm and 5 nm, and the typical diameter of the interference light variable plating sheet is 40 μm. The pigment sheet of the OVI has a much longer period than the microstructure of the micrographic background area B, so the pigment sheet can completely cover the microstructure. After film forming and drying of the OVI, pigment sheets are basically arranged along the plane of the micrographic array layer 3. The anti-counterfeiting element further comprises a hot melt adhesive layer 7 for bonding a protected product.

Observing from one side of the microlens array layer 2, if the observation angle obliquely changes along the stretching direction of the columnar microlens, it can be seen that the micrographic background area B is golden during front observation and green during oblique observation; and if the observation angle obliquely changes perpendicular to the stretching direction of the columnar microlens, it can be seen that graphics with rainbow holographic features have obvious dynamic features formed by the Moire principle (such as motion, scaling and distortion).

Compared with the anti-counterfeiting element shown in FIG. 2, the anti-counterfeiting element shown in FIG. 3 has relatively low color saturation and brightness of the micrographic background area B, but has the advantage that the OVI can be locally arranged through a printing process to form patterns with specific shapes.

It is apparent that the embodiments described above are only a part of the embodiments of the disclosure, but are not all of the embodiments. All other embodiments obtained by those of ordinary skill in the art based on the embodiments in the disclosure without creative effort shall fall within the scope of protection of the disclosure.

It should be noted that the terms used here are only used for describing specific embodiments, but are not intended to limit the exemplary embodiments according to the disclosure. As used here, unless explicitly stated in the context, the singular form is also intended to comprise the plural form. In addition, it should also be understood that when the terms “contain” and/or “comprise” are used in the specification, they indicate the presence of features, steps, operations, devices, components, and/or combinations thereof.

It should be noted that the terms such as “first” and “second” in the specification, claims and above accompanying drawings of the disclosure are used for distinguishing similar objects instead of describing a particular sequence or a precedence order. It should be understood that the data used in this way can be interchanged in appropriate circumstances, so that the embodiments of the disclosure described here can be implemented in a sequence other than those illustrated or described here.

The above descriptions are only preferred embodiments of the disclosure and are not intended to limit the disclosure. It will be apparent to those skilled in the art that various modifications and changes may be made in the disclosure. Any modifications, equivalent replacements, improvements, and the like made within the spirit and principle of the disclosure shall be included within the scope of protection of the disclosure.

1. An anti-counterfeiting element, comprising:
a substrate , the substrate comprising a first surface and a second surface opposite to each other;
a microlens array layer, the microlens array layer being located on the first surface of the substrate;
a micrographic array layer, the micrographic array layer being located on the second surface of the substrate, a side surface of the micrographic array layer far away from the substrate comprising at least micrographic areas and micrographic background areas, there being multiple micrographic areas and multiple micrographic background areas, and the areas being alternately arranged;
a second color layer, the second color layer being located on the side surface of the micrographic array layer far away from the substrate; and
first color layers, the first color layers being located between the micrographic array layer and the second color layer, there being multiple first color layers, and the multiple first color layers being in one-to-one correspondence with the multiple micrographic areas,
wherein one of the first color layer and the second color layer is a metal plating layer and the other is an interference light variable layer.

2. The anti-counterfeiting element according to claim 1, wherein
the depth-to-width ratio of each micrographic area of the multiple micrographic areas on the micrographic array layer is less than the depth-to-width ratio of each micrographic background area of the multiple micrographic background areas on the micrographic array layer; and/or
the specific volume of each micrographic area of the multiple micrographic areas on the micrographic array layer is less than the specific volume of each micrographic background area of the multiple micrographic background areas on the micrographic array layer.

3. The anti-counterfeiting element according to claim 1, wherein
the depth-to-width ratio of each micrographic area of the multiple micrographic areas on the micrographic array layer is less than 0.3; and/or
the depth-to-width ratio of each micrographic background area of the multiple micrographic background areas on the micrographic array layer is greater than 0.3.

4. The anti-counterfeiting element according to claim 1, wherein
the specific volume of each micrographic area of the multiple micrographic areas on the micrographic array layer is greater than or equal to 0 um³/um² and less than 0.5 μm³/μm²; and/or
the specific volume of each micrographic background area of the multiple micrographic background areas on the micrographic array layer is greater than 0.4 μm³/μm² and less than 2 μm³/μm².

5. The anti-counterfeiting element according to claim 1, wherein
the micrographic area comprises multiple lines, the width of a part of the multiple lines is less than 5 μm, and the width of the other part of the lines is greater than 5 μm; and/or
the micrographic background area comprises multiple lines, the width of a part of the multiple lines is less than 5 μm, and the width of the other part of the lines is greater than 5 μm.

6. The anti-counterfeiting element according to claim 1, wherein the metal plating layer comprises one of aluminum, silver, copper, tin, chromium, nickel and titanium.

7. The anti-counterfeiting element according to claim 1, wherein the interference light variable layer comprises an absorption layer, a dielectric layer and a reflecting layer which are stacked in sequence, and the absorption layer is arranged closer to the micrographic array layer compared to the reflecting layer;
the absorption layer comprises one of aluminum, nickel, chromium, silver, copper, tin and titanium; and/or
the dielectric layer comprises one of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ and ZnO; and/or
the reflecting layer comprises one of aluminum, silver, copper, tin, chromium, nickel and titanium.

8. The anti-counterfeiting element according to claim 1, wherein the interference light variable layer is composed of optically variable ink (OVI).

9. The anti-counterfeiting element according to claim 1, wherein the anti-counterfeiting element further comprises a microstructure alleviation layer , and the microstructure alleviation layer is located between the first color layer and the second color layer.

10. The anti-counterfeiting element according to claim 9, wherein a side surface of the microstructure alleviation layer facing the second color layer is a plane.

11. An anti-counterfeiting product, comprising the anti-counterfeiting element according to claim 1.

12. The anti-counterfeiting product according to claim 11, wherein the anti-counterfeiting product comprises one of a label, a hot stamping wide strip, a sticker and a safety line.

13. The anti-counterfeiting product according to claim 11, wherein
the depth-to-width ratio of each micrographic area of the multiple micrographic areas on the micrographic array layer is less than the depth-to-width ratio of each micrographic background area of the multiple micrographic background areas on the micrographic array layer; and/or
the specific volume of each micrographic area of the multiple micrographic areas on the micrographic array layer is less than the specific volume of each micrographic background area of the multiple micrographic background areas on the micrographic array layer.

14. The anti-counterfeiting product according to claim 11, wherein
the depth-to-width ratio of each micrographic area of the multiple micrographic areas on the micrographic array layer is less than 0.3; and/or
the depth-to-width ratio of each micrographic background area of the multiple micrographic background areas on the micrographic array layer is greater than 0.3.

15. The anti-counterfeiting product according to claim 11, wherein
the specific volume of each micrographic area of the multiple micrographic areas on the micrographic array layer is greater than or equal to 0μm³/μm² and less than 0.5 μm³/μm²; and/or
the specific volume of each micrographic background area of the multiple micrographic background areas on the micrographic array layer is greater than 0.4 μm³/μm² and less than 2 μm³/μm².

16. The anti-counterfeiting product according to claim 11, wherein
the micrographic area comprises multiple lines, the width of a part of the multiple lines is less than 5 μm, and the width of the other part of the lines is greater than 5 μm; and/or
the micrographic background area comprises multiple lines, the width of a part of the multiple lines is less than 5 μm, and the width of the other part of the lines is greater than 5 μm.

17. The anti-counterfeiting product according to claim 11, wherein the metal plating layer comprises one of aluminum, silver, copper, tin, chromium, nickel and titanium.

18. The anti-counterfeiting product according to claim 11, wherein
the interference light variable layer comprises an absorption layer, a dielectric layer and a reflecting layer which are stacked in sequence, and the absorption layer is arranged closer to the micrographic array layer compared to the reflecting layer;
the absorption layer comprises one of aluminum, nickel, chromium, silver, copper, tin and titanium; and/or
the dielectric layer comprises one of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ and ZnO; and/or
the reflecting layer comprises one of aluminum, silver, copper, tin, chromium, nickel and titanium.

19. The anti-counterfeiting product according to claim 11, wherein the interference light variable layer is composed of optically variable ink (OVI).

20. The anti-counterfeiting product according to claim 11, wherein the anti-counterfeiting element further comprises a microstructure alleviation layer, and the microstructure alleviation layer is located between the first color layer and the second color layer.
